(19) United States
(12) Patent Application Publication
(10) Pub. No.: US 2015/0279151 A1
(43) Pub. Date: Oct. 1, 2015

(54) REVERSED LOTTERY SYSTEM

(71) Applicant: PARIPLAY LIMITED, Douglas (GB)

(72) Inventor: Gili LISANI, Shoham (IL)

(73) Assignee: PARIPLAY LIMITED, Douglas (GB)

(21) Appl. No.: 14/227,221

(22) Filed: Mar. 27, 2014

(51) Int. Cl. G07F 17/32

(52) U.S. Cl. CPC G07F 17/329; G07F 17/3225

(57) ABSTRACT

A reversed lottery system (RLS) (100) for conducting a lottery game; the RLS comprising: (a) a betting input terminal (BIT) (110) configured for carrying out at least one selling event of at least one lottery ticket to at least one customer; (b) a jackpot module (JM) (120) having a specific value; (c) at least one processor (130) in communication with a computer readable medium (CRM); the processor executes a set of operations received from said CRM; the set of operations are: (i) communicating with the BIT and the JM; (ii) randomly generating a winning set (WS) (140) of numbers and at least one ticket set (TS) (150) of numbers; the TS is generated upon receiving communication regarding at least one selling event; (iii) matching between the WS and the TS and producing a matching score to the match; the TS is a winning TS (WTS) (150A) if the matching score is above a specific threshold; and, (iv) distributing at least part of the specific value of the JM if the TS is the WTS to the customer; wherein the processor is configured to generate the WS prior to at least one selling event and the generation of said TS.

### FIELD OF THE INVENTION

The present invention generally relates to a reversed lottery system (RLS) for conducting a lottery game. More specifically the invention pertains to a lottery system in which the winning numbers are selected at the beginning of the lottery game.

### BACKGROUND OF THE INVENTION

A lottery is a form of gambling which involves the drawing of lots for a prize. Lotteries come in many formats. For example, the prize can be a fixed amount of cash or goods. In this format there is risk to the organizer if insufficient tickets are sold. More commonly the prize fund will be a fixed percentage of the receipts. A popular form of this is the “50-50” draw where the organizers promise that the prize will be 50% of the revenue. Many recent lotteries allow purchasers to select the numbers on the lottery ticket, resulting in the possibility of multiple winners.

Some lottery systems, for example, the California State Lottery, uses a parimutuel system to determine the size of each prize, such that prize values are not fixed, but depend on sales and the number of winning tickets.

The parimutuel system has been in existence since its development in the 1870s. The system was made first for betting games such as horse racing and sporting events. In this system, the money or bets are pooled. After deducting a commission for the house, the payoff odds are then calculated after which the pool is divided equally to the winners. A modified parimutuel system is also may be used in lottery games. If the winning combination has more than one winning ticket holder, then the prize will be split equally to the winners. For lottery players, this system is beneficial especially in the long run. First, for every major lotto draw with no winner, the ticket sales are pooled and portions of it are added to the previous jackpot price and hence, the amount of jackpot prize will increase until a winner is lucky enough to match the winning combination. Since there are many people taking chances in lottery games due to the huge jackpot prize, more money from ticket sales are pooled.

Several patents documents reciting methods for applying pari-mutuel methods in lottery exist. For example, patent application US2003096646 recites a parimutuel method for wagering games played on a computer network system. In another example, patent application US2005227759 discloses a multi-group lotto game which allows for groups having differing payout structures and prize percentages.

However, none of the mentioned above patent applications provide an ongoing lottery system with a progressive jackpot that does not require waiting for a specific deadline in order to know whether a person won or not.

Therefore, there is a long felt and unmet need for a system an method for carrying out a lottery game with a continuously accumulating progressive jackpot in which a person can be announced as winner seconds from buying a ticket.

### SUMMARY

The present invention provides a reversed lottery system (RLS) (100) for conducting a lottery game; the RLS comprising: (a) a betting input terminal (BIT) (110) configured for carrying out at least one selling event of at least one lottery ticket to at least one customer; (b) a progressive jackpot module (PJM) (120) having a specific value and configured to increase its value by a predetermined amount in response to the selling event; (c) at least one processor (130) in communication with a computer readable medium (CRM); the processor executes a set of operations received from the CRM; the set of operations are: (i) communicating with the BIT and the PJM; (ii) randomly generating a winning set (WS) (140) of numbers and at least one ticket set (TS) (150) of numbers; the TS is generated upon receiving communication regarding at least one selling event; (iii) matching between the WS and the TS and producing a matching score to the match; the TS is a winning TS (WTS) (150A) if the matching score is above a specific threshold; and, (iv) distributing at least part of the PJM value if the TS is the WTS to the customer; wherein the processor is configured to generate the WS prior to at least one selling event and the generation of the TS.

It is another object of the current invention to disclose the RLS as defined in any of the above, wherein the WS and the TS comprise X numbers selected from at least one pool of numbers.

It is another object of the current invention to disclose the RLS as defined in any of the above, wherein the X numbers are selected from at least two pools of numbers.

It is another object of the current invention to disclose the RLS as defined in any of the above, wherein part of the X numbers is selected from a first pool of numbers and another part is selected from a second pool of numbers.

It is another object of the current invention to disclose the RLS as defined in any of the above, wherein at least one pool numbers comprise whole single- and double-digit numbers.

It is another object of the current invention to disclose the RLS as defined in any of the above, wherein the BIT is selected from a group consisting of lottery kiosk, the customer's laptop, the customer's mobile phone, the customer's desktop, the user's tablet, video lottery terminal, and any combination thereof.

It is another object of the current invention to disclose the RLS as defined in any of the above, wherein the LT is sold in exchange of a specific amount of money.

It is another object of the current invention to disclose the RLS as defined in any of the above, wherein the predetermined amount is a fixed percent of the amount of money.

It is another object of the current invention to disclose the RLS as defined in any of the above, wherein the PJM contains an initial amount of money.

It is another object of the current invention to disclose the RLS as defined in any of the above, wherein the CRM comprises additional operations to encrypt the WS.

It is another object of the current invention to disclose the RLS as defined in any of the above, wherein a larger part of the value of the PJM is distributed when the matching score is higher.

It is another object of the current invention to disclose the RLS as defined in any of the above, wherein the WTS receives the highest matching score when it matches exactly the WS; the exact match is identical number in identical order of the WS to the WTS.

It is another object of the current invention to disclose the RLS as defined in any of the above, wherein the LT ascribed the WTS having the highest matching score receives the highest part of the PJM value.

It is another object of the current invention to disclose the RLS as defined in any of the above, wherein the highest part of the PJM value is distributed the lottery game ends.

It is another object of the current invention to disclose the RLS as defined in any of the above, wherein at least one customer comprises the customer who purchased an LT at a specific time point to which the WTS was ascribed and any other customer to which an additional LT ascribed to the WTS was sold in a specific timeframe from the time point.

It is another object of the current invention to disclose the RLS as defined in any of the above, wherein the specific timeframe is from about 0.5 seconds to about 3 seconds.

It is another object of the current invention to disclose the RLS as defined in any of the above, wherein the processor comprises: a random number generator, a number database, a WS memory, an encryptor, a matching module, and any combination thereof.

It is another object of the current invention to disclose the RLS as defined in any of the above, wherein the BIT communicates with the PJM and the processor wirelessly.

It is another object of the current invention to disclose a reversed lottery system (RLS) (100) for conducting a lottery game; the RLS comprising: (a) a betting input terminal (BIT) (110) configured for carrying out at least one selling event of at least one lottery ticket (LT) to at least one customer; (b) a progressive jackpot module (PJM) (120) having a specific value and configured to increase its value by a predetermined amount in response to the selling event; (c) at least one processor (130) in communication with a computer readable medium (CRM); the processor executes a set of operations received from the CRM; the set of operations are: (i) communicating with the BIT and the PJM; (ii) randomly generating a winning set (WS) (140) of numbers and at least one ticket set (TS) (150) of numbers; the TS is generated upon receiving communication regarding at least one selling event and is ascribes to the LT; (iii) matching between the WS and the TS and producing a matching score to the match; the TS is a winning TS (WTS) (150A) if the matching score is above a specific threshold; and, (iv) distributing at least part of the PJM value if the TS is the WTS to at least one customer; wherein the processor is configured to generate the WS prior to at least one selling event and the generation of the TS; further wherein at least one customer comprises the customer who purchased an LT at a specific time point to which the WTS was ascribed and any other customer to which an additional LT ascribed to the WTS was sold in a specific timeframe from the time point.

It is another object of the current invention to disclose the RLS as defined in any of the above, wherein the WS and the TS comprise X numbers selected from at least one pool of numbers.

It is another object of the current invention to disclose the RLS as defined in any of the above, wherein the X numbers are selected from at least two pools of numbers.

It is another object of the current invention to disclose the RLS as defined in any of the above, wherein part of the X numbers is selected from a first pool of numbers and another part is selected from a second pool of numbers.

It is another object of the current invention to disclose the RLS as defined in any of the above, wherein at least one pool numbers comprise whole single- and double-digit numbers.

It is another object of the current invention to disclose the RLS as defined in any of the above, wherein the BIT is selected from a group consisting of lottery kiosk, the customer's laptop, the customer's mobile phone, the customer's desktop, the user's tablet, video lottery terminal, and any combination thereof.

It is another object of the current invention to disclose the RLS as defined in any of the above, wherein the LT is sold in exchange of a specific amount of money.

It is another object of the current invention to disclose the RLS as defined in any of the above, wherein the predetermined amount is a fixed percent of the amount of money.

It is another object of the current invention to disclose the RLS as defined in any of the above, wherein the PJM contains an initial amount of money.

It is another object of the current invention to disclose the RLS as defined in any of the above, wherein the CRM comprises additional operations to encrypt the WS.

It is another object of the current invention to disclose the RLS as defined in any of the above, wherein a larger part of the value of the PJM is distributed when the matching score is higher.

It is another object of the current invention to disclose the RLS as defined in any of the above, wherein the WTS receives the highest matching score when it matches exactly the WS; the exact match is an identical number in identical order of the WS to the WTS.

It is another object of the current invention to disclose the RLS as defined in any of the above, wherein the LT ascribed the WTS having the highest matching score receives the highest part of the PJM value.

It is another object of the current invention to disclose the RLS as defined in any of the above, wherein the highest part of the PJM value is distributed the lottery game ends.

It is another object of the current invention to disclose the RLS as defined in any of the above, wherein the specific timeframe is from about 0.5 seconds to about 3 seconds.

It is another object of the current invention to disclose the RLS as defined in any of the above, wherein the processor comprises: a random number generator, a number database, a WS memory, an encryptor, a matching module, and any combination thereof.

It is another object of the current invention to disclose the RLS as defined in any of the above, wherein the BIT communicates with the PJM and the processor wirelessly.

It is another object of the current invention to disclose a reversed lottery system (RLS) (100) for conducting a lottery game; the RLS comprising: (a) a betting input terminal (BIT) (110) configured for carrying out at least one selling event of at least one lottery ticket to at least one customer; (b) a jackpot module (JM) (120) having a specific value determined at the beginning of the lottery game; (c) at least one processor (130) in communication with a computer readable medium (CRM); the processor executes a set of operations received from the CRM; the set of operations are: (i) communicating with the BIT and the JM; (ii) randomly generating a winning set (WS) (140) of numbers and at least one ticket set (TS) (150) of numbers; the TS is generated upon receiving communication regarding at least one selling event; (iii) matching between the WS and the TS and producing a matching score to the match; the TS is a winning TS (WTS) (150A) if the matching score is above a specific threshold; and, (iv) distributing at least part of the JM value if the TS is the WTS to the customer; wherein the processor is configured to generate the WS prior to at least one selling event and the generation of the TS.

It is another object of the current invention to disclose the RLS as defined in any of the above, wherein the WS and the TS comprise X numbers selected from at least one pool of numbers.

It is another object of the current invention to disclose the RLS as defined in any of the above, wherein the X numbers are selected from at least two pools of numbers.

It is another object of the current invention to disclose the RLS as defined in any of the above, wherein part of the X numbers is selected from a first pool of numbers and another part is selected from a second pool of numbers.

It is another object of the current invention to disclose the RLS as defined in any of the above, wherein at least one pool numbers comprise whole single- and double-digit numbers.

It is another object of the current invention to disclose the RLS as defined in any of the above, wherein the BIT is selected from a group consisting of lottery kiosk, the customer's laptop, the customer's mobile phone, the customer's desktop, the user's tablet, video lottery terminal, and any combination thereof.

It is another object of the current invention to disclose the RLS as defined in any of the above, wherein the CRM comprises additional operations to encrypt the WS.

It is another object of the current invention to disclose the RLS as defined in any of the above, wherein a larger part of the value of the JM is distributed when the matching score is higher.

It is another object of the current invention to disclose the RLS as defined in any of the above, wherein the WTS receives the highest matching score when it matches exactly the WS; the exact match is identical number in identical order of the WS to the WTS.

It is another object of the current invention to disclose the RLS as defined in any of the above, wherein the LT ascribed the WTS having the highest matching score receives the highest part of the JM value.

It is another object of the current invention to disclose the RLS as defined in any of the above, wherein the highest part of the JM value is distributed the lottery game ends.

It is another object of the current invention to disclose the RLS as defined in any of the above, wherein at least one customer comprises the customer who purchased an LT at a specific time point to which the WTS was ascribed and any other customer to which an additional LT ascribed to the WTS was sold in a specific timeframe from the time point.

It is another object of the current invention to disclose the RLS as defined in any of the above, wherein the specific timeframe is from about 0.5 seconds to about 3 seconds.

It is another object of the current invention to disclose the RLS as defined in any of the above, wherein the processor comprises: a random number generator, a number database, a WS memory, an encryptor, a matching module, and any combination thereof.

It is another object of the current invention to disclose the RLS as defined in any of the above, wherein the BIT communicates with the JM and the processor wirelessly.

It is another object of the current invention to disclose the RLS as defined in any of the above, wherein the JM value can change during the lottery game.

It is another object of the current invention to disclose a reversed lottery system (RLS) (100) for conducting a lottery game; the RLS comprising: (a) a betting input terminal (BIT) (110) configured for carrying out at least one selling event of at least one lottery ticket to at least one customer; (b) a jackpot module (JM) (120) having a specific value determined at the beginning of the lottery game; (c) at least one processor (130) in communication with a computer readable medium (CRM); the processor executes a set of operations received from the CRM; the set of operations are: (i) communicating with the BIT and the JM; (ii) randomly generating a winning set (WS) (140) of numbers and at least one ticket set (TS) (150) of numbers; the TS is generated upon receiving communication regarding at least one selling event; (iii) matching between the WS and the TS and producing a matching score to the match; the TS is a winning TS (WTS) (150A) if the matching score is above a specific threshold; and, (iv) distributing at least part of the JM value if the TS is the WTS to the customer; wherein the processor is configured to generate the WS prior to at least one selling event and the generation of the TS; further wherein at least one customer comprises the customer who purchased an LT at a specific time point to which the WTS was ascribed and any other customer to which an additional LT ascribed to the WTS was sold in a specific timeframe from the time point.

It is another object of the current invention to disclose the RLS as defined in any of the above, wherein the WS and the TS comprise X numbers selected from at least one pool of numbers.

It is another object of the current invention to disclose the RLS as defined in any of the above, wherein the X numbers are selected from at least two pools of numbers.

It is another object of the current invention to disclose the RLS as defined in any of the above, wherein part of the X numbers is selected from a first pool of numbers and another part is selected from a second pool of numbers.

It is another object of the current invention to disclose the RLS as defined in any of the above, wherein at least one pool numbers comprise whole single- and double-digit numbers.

It is another object of the current invention to disclose the RLS as defined in any of the above, wherein the BIT is selected from a group consisting of lottery kiosk, the customer's laptop, the customer's mobile phone, the customer's desktop, the user's tablet, video lottery terminal, and any combination thereof.

It is another object of the current invention to disclose the RLS as defined in any of the above, wherein the CRM comprises additional operations to encrypt the WS.

It is another object of the current invention to disclose the RLS as defined in any of the above, wherein a larger part of the value of the JM is distributed when the matching score is higher.

It is another object of the current invention to disclose the RLS as defined in any of the above, wherein the WTS receives the highest matching score when it matches exactly the WS; the exact match is identical number in identical order of the WS to the WTS.

It is another object of the current invention to disclose the RLS as defined in any of the above, wherein the LT ascribed the WTS having the highest matching score receives the highest part of the JM value.

It is another object of the current invention to disclose the RLS as defined in any of the above, wherein the highest part of the JM value is distributed the lottery game ends.

It is another object of the current invention to disclose the RLS as defined in any of the above, wherein the processor comprises: a random number generator, a number database, a WS memory, an encryptor, a matching module, and any combination thereof.

It is another object of the current invention to disclose the RLS as defined in any of the above, wherein the BIT communicates with the JM and the processor wirelessly.

It is another object of the current invention to disclose the RLS as defined in any of the above, wherein the JM value can change during the lottery game.

It is another object of the current invention to disclose a gaming processor for conducting a reversed lottery game; the RLS comprising: the gaming processor is in communication with a computer readable medium (CRM); the processor executes a set of operations received from the CRM; the set of operations are characterized by: (a) randomly generating a winning set (WS) of numbers; (b) receiving input from at least one betting input terminal (BIT) regarding the purchase of at least one lottery ticket (LT); (c) ascribing the LT a ticket set (TS) of randomly selected numbers; (d) matching between the WS and the TS and producing a matching score to the match; the TS is a winning TS (WTS) if the matching score is above a specific threshold; and, (e) transferring output to a jackpot module (JM) regarding the matching score.

It is another object of the current invention to disclose the game processor as defined in any of the above, wherein the WS and the TS comprise X numbers selected from at least one pool of numbers.

It is another object of the current invention to disclose the game processor as defined in any of the above, wherein the X numbers are selected from at least two pools of numbers.

It is another object of the current invention to disclose the game processor as defined in any of the above, wherein part of the X numbers is selected from a first pool of numbers and another part is selected from a second pool of numbers.

It is another object of the current invention to disclose the game processor as defined in any of the above, wherein at least one pool numbers comprise whole single- and double-digit numbers.

It is another object of the current invention to disclose the game processor as defined in any of the above, wherein the CRM comprises additional operations to encrypt the WS.

It is another object of the current invention to disclose the game processor as defined in any of the above, wherein the WTS receives the highest matching score when it matches exactly the WS; the exact match is identical number in identical order of the WS to the WTS.

It is another object of the current invention to disclose the game processor as defined in any of the above, wherein the processor comprises: a random number generator, a number database, a WS memory, an encryptor, a matching module, and any combination thereof.

It is another object of the current invention to disclose the game processor as defined in any of the above, wherein the BIT communicates with the JM and the processor wirelessly.

It is another object of the current invention to disclose the game processor as defined in any of the above, wherein the JM is an accumulating jackpot.

It is another object of the current invention to disclose a method for conducting a lottery game by a reversed lottery system (RLS), characterized by steps of: (a) obtaining an RLS comprising, a betting input terminal (BIT), progressive jackpot module (PJM) and a gaming processor; (b) randomly generating a winning set (WS) of numbers by the processor; (c) purchasing at least one lottery ticket (LT) through the BIT; (d) notifying the gaming processor regarding the LT purchase through the BIT; (e) increasing the value of the PJM by a predetermined amount; (f) generating a ticket set (TS) of random numbers by the processor; (g) matching between the WS and the TS and producing a matching score; the TS is a winning TS (WTS) if the matching score is above a specific threshold; and, (h) at least partially distributing the value of the PJM if the TS is the WTS.

It is another object of the current invention to disclose the method as defined in any of the above, additionally comprising a step of selecting X numbers for the WS and the TS from at least one pool of numbers.

It is another object of the current invention to disclose the method as defined in any of the above, additionally comprising a step of selecting the X numbers from at least two pools of numbers.

It is another object of the current invention to disclose the method as defined in any of the above, additionally comprising a step of selecting part of the X numbers from a first pool of numbers and another part from a second pool of numbers.

It is another object of the current invention to disclose the method as defined in any of the above, additionally comprising a step of selecting at least one pool numbers from whole single- and double-digit numbers.

It is another object of the current invention to disclose the method as defined in any of the above, additionally comprising a step of selecting the BIT from a group consisting of lottery kiosk, the customer's laptop, the customer's mobile phone, the customer's desktop, the user's tablet, video lottery terminal, and any combination thereof.

It is another object of the current invention to disclose the method as defined in any of the above, additionally comprising a step of selling the LT in exchange of a specific amount of money.

It is another object of the current invention to disclose the method as defined in any of the above, additionally comprising a step of determining the predetermined amount as a fixed percent of the amount of money.

It is another object of the current invention to disclose the method as defined in any of the above, additionally comprising a step of providing the PJM an initial value.

It is another object of the current invention to disclose the method as defined in any of the above, additionally comprising a step of encrypting the WS.

It is another object of the current invention to disclose the method as defined in any of the above, additionally comprising a step of distributing a larger amount of the value of the PJM when the matching score is higher.

It is another object of the current invention to disclose the method as defined in any of the above, additionally comprising a step of giving the highest matching score to a full match between the WS and the WTS; the full match is identical number in identical order of the WS to the WTS.

It is another object of the current invention to disclose the method as defined in any of the above, additionally comprising a step of distributing the highest part of the PJM value if the WTS receives the highest score.

It is another object of the current invention to disclose the method as defined in any of the above, additionally comprising a step of ending the lottery game if the highest part of the PJM value is distributed.

It is another object of the current invention to disclose the method as defined in any of the above, additionally comprising a step of selecting at least one customer to be the customer who purchased an LT at a specific time point to which the WTS was ascribed and any other customer to which an additional LT ascribed to the WTS was sold in a specific timeframe from the time point.

It is another object of the current invention to disclose the method as defined in any of the above, additionally comprising a step of selecting the specific timeframe in the range of about 0.5 seconds to about 3 seconds.

It is another object of the current invention to disclose the method as defined in any of the above, additionally comprising a step of selecting at least one item to comprise the processor from a group consisting of: a random number generator, a number database, a WS memory, an encryptor, a matching module, and any combination thereof.

It is another object of the current invention to disclose the method as defined in any of the above, additionally comprising a step of communicating the BIT with the PJM and the processor wirelessly.

It is another object of the current invention to disclose a method for conducting a lottery game by a reversed lottery system (RLS), characterized by steps of: (a) obtaining an RLS comprising, a betting input terminal (BIT), progressive jackpot module (PJM) and a gaming processor; (b) randomly generating a winning set (WS) of numbers by the processor; (c) purchasing at least one lottery ticket (LT) through the BIT; (d) notifying the gaming processor regarding the LT purchase through the BIT; (e) increasing the value of the PJM by a predetermined amount; (f) generating a ticket set (TS) of random numbers by the processor; (g) matching between the WS and the TS and producing a matching score; the TS is a winning TS (WTS) if the matching score is above a specific threshold; and, (h) at least partially distributing the value of the PJM to at least one customer if the TS is the WTS; at least one customer comprises the customer who purchased an LT at a specific time point to which the WTS was ascribed and any other customer to which an additional LT ascribed to the WTS was sold in a specific timeframe from the time point.

It is another object of the current invention to disclose the method as defined in any of the above, additionally comprising a step of selecting X numbers for the WS and the TS from at least one pool of numbers.

It is another object of the current invention to disclose the method as defined in any of the above, additionally comprising a step of selecting the X numbers from at least two pools of numbers.

It is another object of the current invention to disclose the method as defined in any of the above, additionally comprising a step of selecting part of the X numbers from a first pool of numbers and another part from a second pool of numbers.

It is another object of the current invention to disclose the method as defined in any of the above, additionally comprising a step of selecting at least one pool numbers from whole single- and double-digit numbers.

It is another object of the current invention to disclose the method as defined in any of the above, additionally comprising a step of selecting the BIT from a group consisting of lottery kiosk, the customer's laptop, the customer's mobile phone, the customer's desktop, the user's tablet, video lottery terminal, and any combination thereof.

It is another object of the current invention to disclose the method as defined in any of the above, additionally comprising a step of selling the LT in exchange of a specific amount of money.

It is another object of the current invention to disclose the method as defined in any of the above, additionally comprising a step of determining the predetermined amount as a fixed percent of the amount of money.

It is another object of the current invention to disclose the method as defined in any of the above, additionally comprising a step of providing to the PJM an initial value.

It is another object of the current invention to disclose the method as defined in any of the above, additionally comprising a step of encrypting the WS.

It is another object of the current invention to disclose the method as defined in any of the above, additionally comprising a step of distributing a larger amount of the value of the PJM when the matching score is higher.

It is another object of the current invention to disclose the method as defined in any of the above, additionally comprising a step of giving the highest matching score to a full match between the WS and the WTS; the full match is identical number in identical order of the WS to the WTS.

It is another object of the current invention to disclose the method as defined in any of the above, additionally comprising a step of distributing the highest part of the PJM value if the WTS receives the highest score.

It is another object of the current invention to disclose the method as defined in any of the above, additionally comprising a step of ending the lottery game if the highest part of the PJM value is distributed.

It is another object of the current invention to disclose the method as defined in any of the above, additionally comprising a step of selecting at least one item to comprise the processor from a group consisting of: a random number generator, a number database, a WS memory, an encryptor, a matching module, and any combination thereof.

It is another object of the current invention to disclose the method as defined in any of the above, additionally comprising a step of communicating the BIT with the PJM and the processor wirelessly.

It is another object of the current invention to disclose a method for conducting a lottery game by a reversed lottery system (RLS), characterized by steps of: (a) obtaining an RLS comprising, a betting input terminal (BIT), jackpot module (JM) and a gaming processor; (b) determining the value of the JP; (c) randomly generating a winning set (WS) of numbers by the processor; (d) purchasing at least one lottery ticket (LT) through the BIT; (e) notifying the gaming processor regarding the LT purchase through the BIT; (f) generating a ticket set (TS) of random numbers by the processor; (g) matching between the WS and the TS and producing a matching score; the TS is a winning TS (WTS) if the matching score is above a specific threshold; and, (h) at least partially distributing the value of the JM if the TS is the WTS.

It is another object of the current invention to disclose the method as defined in any of the above, additionally comprising a step of selecting X numbers for the WS and the TS from at least one pool of numbers.

It is another object of the current invention to disclose the method as defined in any of the above, additionally comprising a step of selecting the X numbers from at least two pools of numbers.

It is another object of the current invention to disclose the method as defined in any of the above, additionally comprising a step of selecting part of the X numbers from a first pool of numbers and another part from a second pool of numbers.

It is another object of the current invention to disclose the method as defined in any of the above, additionally comprising a step of selecting at least one pool numbers from whole single- and double-digit numbers.

It is another object of the current invention to disclose the method as defined in any of the above, additionally comprising a step of selecting the BIT from a group consisting of lottery kiosk, the customer's laptop, the customer's mobile phone, the customer's desktop, the user's tablet, video lottery terminal, and any combination thereof.

It is another object of the current invention to disclose the method as defined in any of the above, additionally comprising a step of selling the LT in exchange of a specific amount of money.

It is another object of the current invention to disclose the method as defined in any of the above, additionally comprising a step of determining the predetermined amount as a fixed percent of the amount of money.

It is another object of the current invention to disclose the method as defined in any of the above, additionally comprising a step of encrypting the WS.

It is another object of the current invention to disclose the method as defined in any of the above, additionally comprising a step of distributing a larger amount of the value of the JM when the matching score is higher.

It is another object of the current invention to disclose the method as defined in any of the above, additionally comprising a step of giving the highest matching score to a full match between the WS and the WTS; the full match is identical number in identical order of the WS to the WTS.

It is another object of the current invention to disclose the method as defined in any of the above, additionally comprising a step of distributing the highest part of the PJM value if the WTS receives the highest score.

It is another object of the current invention to disclose the method as defined in any of the above, additionally comprising a step of ending the lottery game if the highest part of the PJM value is distributed.

It is another object of the current invention to disclose the method as defined in any of the above, additionally comprising a step of selecting at least one customer to be the customer who purchased an LT at a specific time point to which the WTS was ascribed and any other customer to which an additional LT ascribed to the WTS was sold in a specific timeframe from the time point.

It is another object of the current invention to disclose the method as defined in any of the above, additionally comprising a step of selecting the specific timeframe in the range of about 0.5 seconds to about 3 seconds.

It is another object of the current invention to disclose the method as defined in any of the above, additionally comprising a step of selecting at least one item to comprise the processor from a group consisting of: a random number generator, a number database, a WS memory, an encryptor, a matching module, and any combination thereof.

It is another object of the current invention to disclose the method as defined in any of the above, additionally comprising a step of changing the jackpot during the lottery game.

It is another object of the current invention to disclose the method as defined in any of the above, additionally comprising a step of communicating the BIT with the PJM and the processor wirelessly.

It is another object of the current invention to disclose a method for conducting a lottery game by a reversed lottery system (RLS), characterized by steps of: (a) obtaining an RLS comprising, a betting input terminal (BIT), progressive jackpot module (PJM) and a gaming processor; (b) determining the value of the JP; (c) randomly generating a winning set (WS) of numbers by the processor; (d) purchasing at least one lottery ticket (LT) through the BIT; (e) notifying the gaming processor regarding the LT purchase through the BIT; (f) generating a ticket set (TS) of random numbers by the processor; (g) matching between the WS and the TS and producing a matching score; the TS is a winning TS (WTS) if the matching score is above a specific threshold; and, (h) at least partially distributing the value of the JM to at least one customer if the TS is the WTS; at least one customer comprises the customer who purchased an LT at a specific time point to which the WTS was ascribed and any other customer to which an additional LT ascribed to the WTS was sold in a specific timeframe from the time point.

It is another object of the current invention to disclose the method as defined in any of the above, additionally comprising a step of selecting X numbers for the WS and the TS from at least one pool of numbers.

It is another object of the current invention to disclose the method as defined in any of the above, additionally comprising a step of selecting the X numbers from at least two pools of numbers.

It is another object of the current invention to disclose the method as defined in any of the above, additionally comprising a step of selecting part of the X numbers from a first pool of numbers and another part from a second pool of numbers.

It is another object of the current invention to disclose the method as defined in any of the above, additionally comprising a step of selecting at least one pool numbers from whole single- and double-digit numbers.

It is another object of the current invention to disclose the method as defined in any of the above, additionally comprising a step of selecting the BIT from a group consisting of lottery kiosk, the customer's laptop, the customer's mobile phone, the customer's desktop, the user's tablet, video lottery terminal, and any combination thereof.

It is another object of the current invention to disclose the method as defined in any of the above, additionally comprising a step of selling the LT in exchange of a specific amount of money.

It is another object of the current invention to disclose the method as defined in any of the above, additionally comprising a step of determining the predetermined amount as a fixed percent of the amount of money.

It is another object of the current invention to disclose the method as defined in any of the above, additionally comprising a step of encrypting the WS.

It is another object of the current invention to disclose the method as defined in any of the above, additionally comprising a step of distributing a larger amount of the value of the PJM when the matching score is higher.

It is another object of the current invention to disclose the method as defined in any of the above, additionally comprising a step of giving the highest matching score to a full match between the WS and the WTS; the full match is identical number in identical order of the WS to the WTS.

It is another object of the current invention to disclose the method as defined in any of the above, additionally comprising a step of distributing the highest part of the PJM value if the WTS receives the highest score.

It is another object of the current invention to disclose the method as defined in any of the above, additionally comprising a step of ending the lottery game if the highest part of the PJM value is distributed.

It is another object of the current invention to disclose the method as defined in any of the above, additionally comprising a step of selecting at least one item to comprise the processor from a group consisting of: a random number generator, a number database, a WS memory, an encryptor, a matching module, and any combination thereof.

It is another object of the current invention to disclose the method as defined in any of the above, additionally comprising a step of communicating the BIT with the JM and the processor wirelessly.

It is another object of the current invention to disclose the method as defined in any of the above, additionally comprising a step of communicating the BIT with the PJM and the processor wirelessly.

### BRIEF DESCRIPTION OF THE FIGURES

In the following detailed description of the preferred embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1A is a schematic illustration of reversed lottery system (RLS) for conducting a lottery game;

FIG. 1B is a schematic illustration of reversed lottery system (RLS) for conducting a lottery game;

FIG. 2 is a schematic illustration showing different types of betting input terminals (BIT) in communication with a processor;

FIG. 3 is a schematic flow diagram illustrating a method for conducting a lottery game by using an RLS having a progressive jackpot (300); and,

FIG. 4 is a schematic flow diagram illustrating a method for conducting a lottery game by using an RLS having a regular jackpot (400).

### DETAILED DESCRIPTION OF THE EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

This invention recites or refers to a pari-mutuel lottery game in which first a winning set (WS) of numbers are picked and only then tickets are purchased, each with a set of numbers. In this way the set of numbers of the ticket are immediately compared to the WS and winning can happen at every minute. There is no deadline, once a perfect match is made the game ends. This is dramatically different from usual lottery games in which the WS is the last thing the processor done. In regular lottery games first tickets are bought with set of numbers and there is a predetermined deadline. When the deadline arrives the WS is randomly selected and compared to the sets of numbers of each purchased ticket.

The invention further recites a method for dealing with multiple winners in a specific timeframe. Since in many lottery game systems there are thousands of betting station there is a possibility of two lottery tickets winning at time differences of milliseconds. In this case, the current invention discloses a method in which the system pauses for a specific timeframe (about 1-3 seconds) when a winning ticket is purchased. Every other winning ticket purchased within this timeframe splits the prize with the first winning ticket. The prize is either distributed evenly or according to the degree of match of the set of numbers each ticket has.

The term “parimutuel” refers hereinafter to a betting system in which all bets of a particular type are placed together in a pool; taxes and the “house-take” or “vig” are removed, and payoff odds are calculated by sharing the pool among all winning bets.

The term “random number generator” refers hereinafter to a computational or physical device designed to generate a sequence of numbers or symbols that lack any pattern, i.e. appear random. The number database may be included in the gaming server.

The term “gaming processor” refers hereinafter to a processor that carries out all the operation of the lottery game, including selecting a pool of number, randomly selecting a winning set of numbers from the pool, randomly selecting a set of numbers for every purchased ticket, comparing between the numbers selected for every purchased ticket and the winning set of numbers and deciding whether a purchased ticket is a winning ticket. The game engine may also manage the jackpot as well as include an encryptor for encrypting the winning set of numbers.

The term “number database” refers hereinafter to a database of numbers which numbers for the pool of numbers are selected. In a preferred embodiment the number database comprises only whole numbers and preferably single-digit or a double digit number. The number database may be included in the gaming server.

The processor (130) is a main entity communicating with all BITs (110) as well as the PJM (120). The processor is in communication with a computer readable medium (CRM) that executes sets of operations given by it. The first operation the processor executes at the beginning of a new lottery game is to select randomly a winning set (WS) of numbers.

The term “pool of numbers” refers hereinafter to a group of number selected in any manner (random or non-random) from which a set of winning numbers are randomly selected for a lottery game. From the exact same pool from which the winning numbers were selected the numbers for every ticket purchased are also randomly selected.

The term “winning set (WS)” refers hereinafter to a set of specific amount of numbers randomly selected from a predefined pool of numbers. The order in which the numbers are selected is important. The winning set is determined at the beginning of a lottery game and the purpose of the game is to purchase a ticket which issues the exact set of numbers in the exact order.

The term “winning number memory” refers hereinafter to a module in the gaming server which stores the WS selected at the beginning of the game by the RNG. The WS is stored until the game ends. When a new game starts the previous WS is erased and a new WS is stored. The winning number memory may be part of the gaming server.

The term “matching module” refers hereinafter to a module that compares the TS to the WS. The comparing module gives an output of a matching score. If the score is below a predetermined threshold then the lottery card to which the TS was ascribes loses and nothing happens. If the score is above the threshold then TS is a winning TS and the lottery ticket to which it was ascribed is a winning ticket and the customer who bought is receives a prize. The prize may be the whole jackpot if there was a perfect match between the TS and the WS (a perfect match means same numbers in identical order). Lower score is given for imperfect match.

The term “ticket set (TS)” refers hereinafter to a set of specific amount of numbers randomly selected from the same pool of numbers used to select the winning set. The amount of numbers in the set is the exact amount as in the winning set. The order in which the numbers are selected is important.

The term “winning ticket set (WTS)” refers hereinafter to a ticket set having a matching score above a certain threshold. The WTS may be set with perfect match or a partial match.

The term “losing ticket set (LTS)” refers hereinafter to a ticket set having a matching score lower from the determined threshold. All numbers may be different, only part of the numbers can be different, the numbers may be identical but there order of selection can be different.

The term “progressive jackpot module” refers hereinafter to a jackpot where the value of the jackpot increases by an amount each game (usually a certain percent from the cost of the lottery ticket). The purchase of every lottery ticket increases the value of the jackpot with no effect whether the ticket is winning or losing. The starting progressive jackpot may include a starting sum provided by the organizer of the game. Once a WTS is purchased part of the sum or the entire sum accumulated in the jackpot goes to the customer who bought the winning lottery ticket. The part of the jackpot transferred to the customer depends on the matching score the TS his lottery ticket was ascribed. The whole jackpot is transferred to a customer which his ticket was ascribed a WTS with a perfect match to the WS. In a preferred embodiment the jackpot is divided evenly between the purchaser of the WTS and any other customer purchasing a WTS in a certain timeframe from the purchasing event of the first WTS. The timeframe is several seconds (about 1-3 seconds). If no WTS were bought in this timeframe the purchaser of the WTS gets the entire jackpot.

In a preferred, embodiment not the whole value of the jackpot is transferred to the customer even in the case of a perfect match. For example, he may receive 99% of it and the rest may go to charity.

If in this timeframe several customers purchased lottery tickets to which a WTS were ascribed but the WTS received different matching scores than the amount to be distributed from the jackpot is accumulated and distributed evenly between all the winning customer or it is divided in relation to the matching score each card received. The higher the matching score the higher is the share the customer receives.

The term “betting input terminal (BIT)” refers hereinafter to any computerized device or a lottery stand having a computerized system for selling lottery tickets from which a ticket to a lottery game can be purchased. The BIT is in connection with the gaming processor and the progressive jackpot module (PJM). The BIT gives said PJM and said gaming server input regarding the purchase of a lottery ticket. The connection is either wired or wireless. Once a ticket is purchased through the BIT, the gaming server randomly picks a number from a pool of numbers and presents it to the BIT together with the outcome of winning or losing. More specifically, the term relates to a lottery kiosk, said customer's laptop, said customer's mobile phone, said customer's desktop, said user's tablet, video lottery terminal, etc.

The term “lottery ticket (LT)” refers hereinafter to a ticket purchased from a BIT. The ticket may be virtual or real. Each lottery ticket is ascribed a ticket set of numbers randomly selected by the gaming processor. A winning ticket is a ticket to which was ascribed a WTS. If a customer bought a winning ticket than he is entitled to at least a share of the progressive jackpot. If the ascribed TS had a perfect match to the winning set than the customer receives the whole jackpot and game ends.

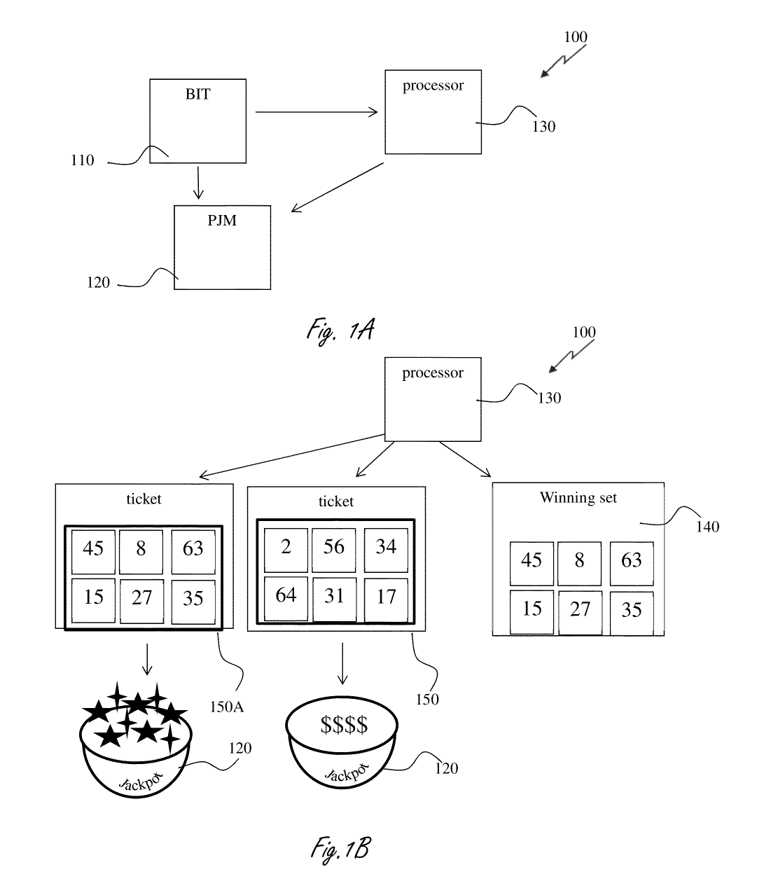

Reference is now made to FIG. 1A which is a schematic illustration of reversed lottery system (RLS) (100) for conducting a lottery game. The RLS comprises three major modules: betting input terminal (BIT) (110), a progressive jackpot module (PJM) (120) and a gaming processor (130).

The betting input terminal (BIT) (110) is a computerized device from which a lottery ticket (LT) can be purchased by a customer. The BIT is in communication with the PJM (120) and the gaming processor (130). The communication may be wireless or not. In a preferred embodiment there are dozens to thousands of BITs scattered around a region (country, state, city, district, etc.), each in communication with the PJM and the processor. The BIT transfers input regarding the purchase of an LT to the PJM and the gaming processor.

The PJM (120) is a module for handling the money collected during the lottery game. The PJM increases its value data by a specific amount every time it is reported from a BIT on the purchase of an LT. The PJM receives input from the BIT regarding the purchase of an LT and the output of the PJM is the increase of the value of the jackpot by a certain amount.

In another embodiment, the jackpot is not progressive. The amount in the jackpot is set at the beginning of the game. The jackpot may stay steady until there is winner guessing the full set of number or it may be decreased each time there is a winner who did not win the full prize. The jackpot may also be changed during the game according to predetermined rules.

In a preferred embodiment, the specific amount increase of the jackpot is a certain percent of the cost of the LT paid by a customer. For example, if the LT costs $10 then $5 goes to the jackpot and the other $5 goes to the organizers of the lottery game. In any case, this increase is fixed and does not depend whether the ticket is winning or not.

In another preferred embodiment, the lottery game begins with a certain amount of money so even if the first purchased ticket is winning then there is a prize. This initial amount of money is provided by the organizers of the lottery game.

The PGM increases as long as no winning tickets are purchased. It decreases or is zeroed in the case of the purchase of a winning card.

Reference is now made to FIG. 1B. The gaming processor (130) is a main entity communicating with all BITs (110) as well as the PJM (120). The processor is in communication with a computer readable medium (CRM) that executes sets of operations given by it. The first operation the processor executes in the beginning of a new lottery game is to select randomly a winning set (WS) of numbers (140). The processor may comprise a random number generator (RNG) which generated the random numbers. The WS is randomly selected from a pool of numbers.

In a preferred embodiment, the numbers are whole single- or double-digit numbers. Basically the pool of numbers is selected from 1-99. It may also contain triple digit numbers and then the pool of numbers is selected from 1-999, or other multiple digit numbers. The processor may include a number database comprising these numbers from which the pool of numbers is selected.

In a preferred embodiment, the selected WS (140) is stored in the memory of the processor. The processor may also comprise an encryptor for encrypting the WS before storing in the processor memory.

The processor receives input from the BIT regarding every LT purchased. Once the processor receives this signal it executes a series of operations. The first operation is ascribe the LT a ticket set (TS) (150) of randomly selected numbers. The numbers of the TS are chosen from the same pool of numbers used to select the WS. In the next step the TS is matched to the WS. This may be done by a matching module comprising the processor. The TS and the WS are compared for the identity of the numbers and their order. The matching process results in a matching score reflecting the degree of match of the TS to the WS. If the score is above a certain predetermined threshold than the TS is said to be a WTS (150A) and the owner of the LT to which the WTS was ascribed is entitled for at least part of the jackpot. If the match is perfect (150A) (same numbers in the same order) then the owner of the LT receives the entire sum accumulated in the jackpot and the lottery game ends. Regarding imperfect match, the organizers decides from which degree of match a prize is distributed and this is reflected in the matching score threshold. In the case of an imperfect match that is above the threshold then the winner receives a certain percent of the jackpot. In theory the threshold can be high so only a perfect match will receive the jackpot.

In a preferred embodiment, the processor has further operations to pause for a predetermined timeframe (1-3 seconds) once a WTS is ascribed to an LT. If another WTS is ascribe to an LT in this timeframe than the winners split the prize. If both tickets received TS with the same matching score than they divide the jackpot evenly or they may split it according to the matching score. The TS that received a higher matching score will get a larger share from the one receiving a lower matching score. The output of the matching score and whether it is a WTS ad its value is forwarded to the PJM.

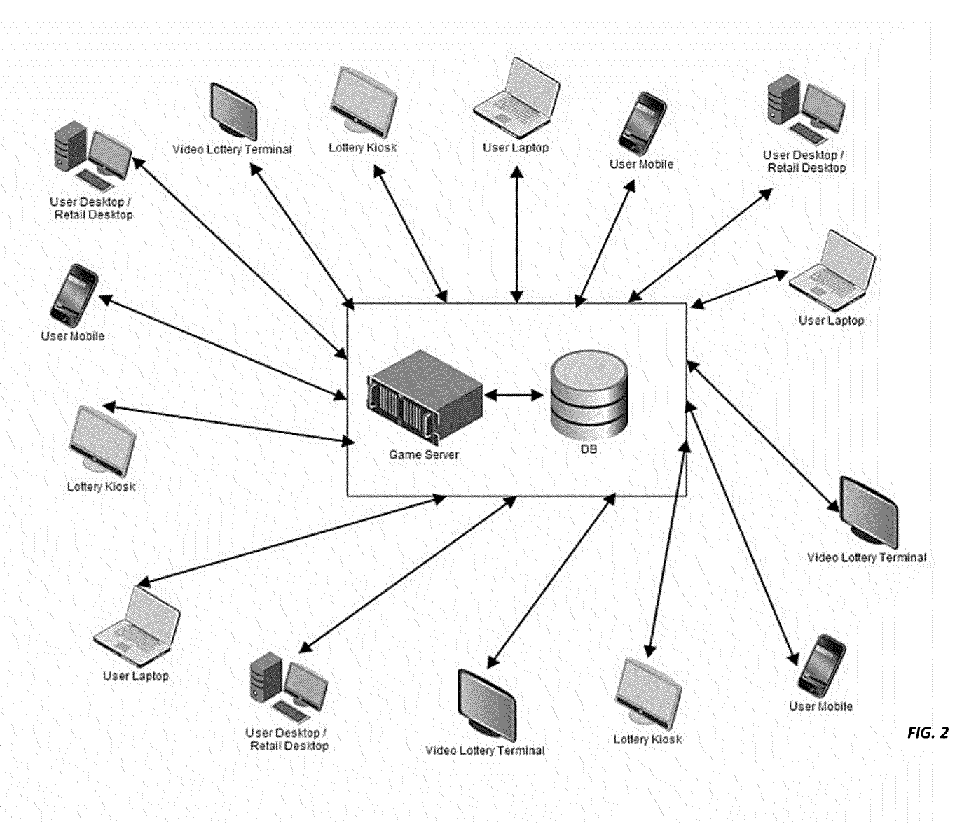

Reference is now made to FIG. 2 which is a schematic illustration showing different types of betting input terminals (BIT) in communication with a processor that runs the lottery game. The BITs may personal computers like laptops, smartphones, tablets and despots from which a lottery ticket can be purchased. The BITs may also by computerized devices in lottery stations placed in public spots for self-use or for use through a lottery agent.

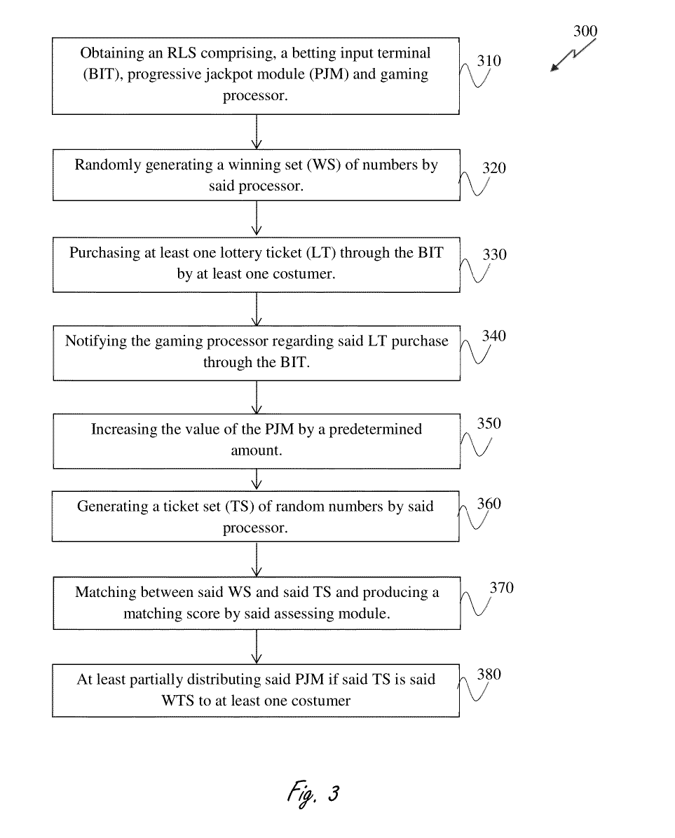

Reference is now made to FIG. 3 which is a schematic flow diagram illustrating a method for conducting a lottery game by using an RLS (300) having a progressive jackpot. In the first step (310), an RLS is obtained. The RLS comprises a BIT, a PJM and a gaming processor. In the second step (320), the gaming processor randomly selects a winning set (WS) of numbers from a pool of numbers. Then a lottery ticket (LT) is purchased through a BIT (330) by a customer. The gaming processor is notified regarding the ticket purchase (340). In response to the notification the value of the PJM increases. (350) The increase is a predefined sum which in a preferred embodiment is a part of the cost of the ticket. In response to purchasing the LT the gaming processor additionally ascribes the LT a ticket set (TS) of randomly selected set of numbers (360). These numbers are selected from the same pool of numbers used to select the WS. The amount of numbers in the WS and TS are identical. The gaming processor matches between the WS and the TS and gives the match a matching score (370). If the matching score is above a predetermined threshold then the TS is a winning ticket set (WTS) and it is entitled for at least part of the sum accumulated in the jackpot (380).

Reference is still made to FIG. 3. In a preferred embodiment, the customer winning the PJM includes the customer which his ticket received a winning ticket set as well as every other customer who received a winning ticket set at a predetermined time frame after the first customer won.

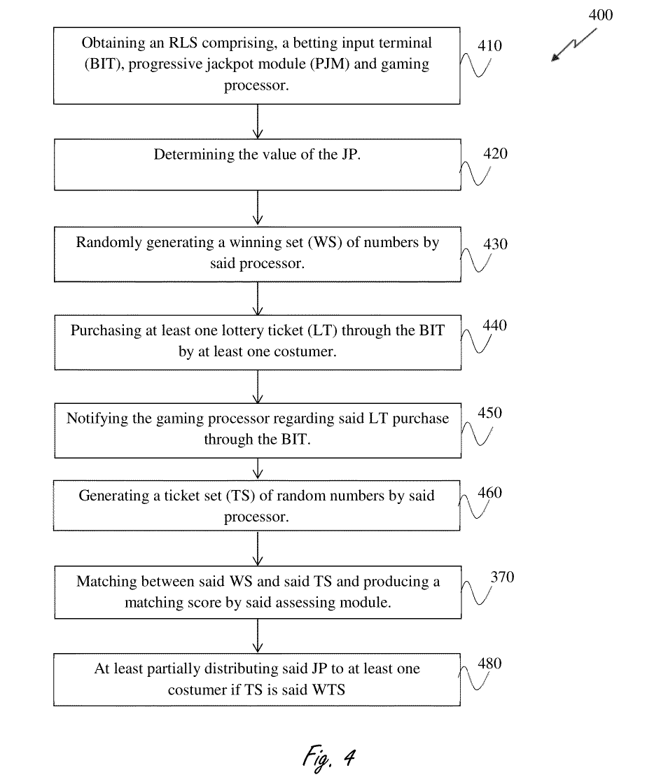

Reference is now made to FIG. 4 which is a schematic flow diagram illustrating a method for conducting a lottery game by using an RLS having a regular jackpot (400). Basically the method is identical to the method described for FIG. 3. The main difference is that the jackpot is not progressive, meaning that a certain sum is announced at the beginning of the game (420) and it does change according to the amount of tickets bought. In a specific embodiment the sum can be updated once in a while but it is not related to ticket purchasing. If there is a change in the sum it is done by the house which provides the sum of money.

1. A reversed lottery system (RLS) (100) for conducting a lottery game; said RLS comprising:
a. a betting input terminal (BIT) (110) configured for carrying out at least one selling event of at least one lottery ticket to at least one customer;
b. a jackpot module (JM) (120) having a specific value;
c. at least one processor (130) in communication with a computer readable medium (CRM); said processor executes a set of operations received from said CRM; said set of operations are:
i. communicating with said BIT and said JM;
ii. randomly generating a winning set (WS) (140) of numbers and at least one ticket set (TS) (150) of numbers; said TS is generated upon receiving communication regarding said at least one selling event;
iii. matching between said WS and said TS and producing a matching score to said match; said TS is a winning TS (WTS) (150A) if said matching score is above a specific threshold; and,
iv. distributing at least part of said specific value of said JM if said TS is said WTS to said customer;
wherein said processor is configured to generate said WS prior to said at least one selling event and the generation of said TS.

2. The RLS of claim 1, wherein JM is a progressive jackpot module (JPM); said specific value of said JPM increases by a predetermined amount in response to said selling event.

3. The RLS of claim 1, wherein said specific value of said JM is determined at the beginning of said lottery game.

4. The RLS of claim 1, wherein said at least one customer comprises the customer who purchased an LT at a specific time point to which said WTS was ascribed and any other customer to which an additional LT ascribed to said WTS was sold in a specific timeframe from said time point; said specific timeframe is between about 0.5 seconds to about 3 seconds.

5. The RLS of claim 1, wherein a larger part of said value of said JM is distributed when said matching score is higher.

6. The RLS of claim 1, wherein said WTS receives the highest matching score when it matches exactly said WS; said exact match is identical number in identical order of said WS to said WTS.

7. The RLS of claim 1, wherein said LT ascribed said WTS having said highest matching score receives the highest part of said JM value.

8. The RLS of claim 7, wherein said highest part of said JM value is distributed said lottery game ends.

9. The RLS of claim 1, wherein said processor comprises: a random number generator, a number database, a WS memory, an encryptor, a matching module, and any combination thereof.

10. A gaming processor for conducting a reversed lottery game; said gaming processor is in communication with a computer readable medium (CRM); said processor executes a set of operations received from said CRM; said set of operations are characterized by:
a. randomly generating a winning set (WS) of numbers;
b. receiving input from at least one betting input terminal (BIT) regarding the purchase of at least one lottery ticket (LT);
c. ascribing said LT a ticket set (TS) of randomly selected numbers;
d. matching between said WS and said TS and producing a matching score to said match; said TS is a winning TS (WTS) if said matching score is above a specific threshold; and,
e. transferring output to a jackpot module (JM) regarding said matching score.

11. The RLS of claim 10, wherein said JM is an accumulating jackpot.

12. A method for conducting a lottery game by a reversed lottery system (RLS), characterized by steps of:
a. obtaining an RLS comprising, a betting input terminal (BIT), a jackpot module (JM) and a gaming processor;
b. randomly generating a winning set (WS) of numbers by said processor;
c. purchasing at least one lottery ticket (LT) through said BIT;
d. notifying said gaming processor regarding said LT purchase through said BIT;
e. generating a ticket set (TS) of random numbers by said processor;
f. matching between said WS and said TS and producing a matching score; said TS is a winning TS (WTS) if said matching score is above a specific threshold; and,
g. at least partially distributing the value of said JM if said TS is said WTS.

13. The method of claim 12, additionally comprising a step of selecting said JM to be a progressive jackpot module; JM is a progressive jackpot module (PJM); said value of said PJM increases by a predetermined amount in response to said selling event.

14. The method of claim 12, additionally comprising a step of determining said value of said JM at the beginning of said lottery game.

15. The method of claim 12, additionally comprising a step of distributing a larger amount of said value of said JM when said matching score is higher.

16. The method of claim 12, additionally comprising a step of giving the highest matching score to a full match between said WS and said WTS; said full match is identical number in identical order of said WS to said WTS.

17. The method of claim 12, additionally comprising a step of distributing the highest part of said PJM value if said WTS receives said highest score.

18. The method of claim 17, additionally comprising a step of ending said lottery game if said highest part of said PJM value is distributed.

19. The method of claim 12, additionally comprising a step of selecting said at least one customer to be the customer who purchased an LT at a specific time point to which said WTS was ascribed and any other customer to which an additional LT ascribed to said WTS was sold in a specific timeframe from said time point; said specific timeframe is in the range of about 0.5 seconds to about 3 seconds.

20. The method of claim 12, additionally comprising a step of selecting at least one item to comprise said processor from a group consisting of: a random number generator, a number database, a WS memory, an encryptor, a matching module, and any combination thereof.
